(19) United States
(12) Patent Application Publication
(10) Pub. No.: US 2023/0363582 A1
(43) Pub. Date: Nov. 16, 2023

(54) EASY CLEAN CONTACT GRILL

(71) Applicant: Spectrum Brands, Inc., Middleton, WI (US)

(72) Inventors: Firdaus Sameer Nandoliya, Verona, WI (US); Noah C. Pulvermacher, Madison, WI (US); Maciej Murzynski, Verona, WI (US); Jacob D. Smith, Monona, WI (US); Benjamin M. Cleppe, Verona, WI (US)

(21) Appl. No.: 18/029,301

(22) PCT Filed: Sep. 30, 2021
(86) PCT No.: PCT/US2021/052917

§ 371 Date: Mar. 29, 2023

Related U.S. Application Data
(60) Provisional application No. 63/086,779, filed on Oct. 2, 2020.

(51) Int. Cl. A47J 37/06; B08B 3/04

(52) U.S. Cl. CPC A47J 37/0611; B08B 3/04

(57) ABSTRACT

A contact grill includes upper and lower grill assemblies connected together by a hinge assembly. Contact grills of the present invention are advantageously easier to clean including components that can be submerged in water or washed within a dishwasher. In one aspect of the present invention, the upper and lower grill assemblies are fully separable from one another and from the hinge assembly so that the upper and lower grill assemblies, each comprising a housing, grill plate, and heating element, are free of electrical components so that they can be submerged or washed in a dishwasher. In another aspect of the present invention, upper and lower grill plates that are assembled with respective upper and lower heating elements are separable from an assembly of upper and lower housings connected together with a hinge assembly. All electrical components are provided within the hinge and housings assembly so that the grill plates and heating elements can be separated from the contact grill to be submerged or washed in a dishwasher.

### CROSS REFERENCE TO RELATED APPLICATIONS

This application claims priority to and the benefit of U.S. Provisional Patent Application No. 63/086,779, filed Oct. 2, 2020, the entire contents of which are incorporated herein by reference in their entireties.

### TECHNICAL FIELD

The present invention is directed to contact grills and in particular to improved contact grills that are more easily cleaned.

### BACKGROUND

A contact grill generally comprises upper and lower grill plates that are typically housed within upper and lower housings, respectively, that are hinged together. Each of the grill plates can be controllably heated. As such, a food product, for example one or more burgers, can be cooked by being placed on the lower grill plate surface, the upper grill plate then lowered onto and in substantially full contact with the food product, while the grill plates are heated. Contact grills are defined by the ability to cook both sides of a food product at the same time by a set of movable grill plates. Typically, the heating elements are electrical resistive heating elements such as cal-rod heating elements as are themselves well known.

Typically also, the upper and lower housings are hinged together by way of a floating hinge that allows the contact grill to accommodate different thickness food products and enhances the ability of the upper grill plate to lie on the food product to substantially be in full contact with the food product. George Foreman® grills are a popular type of contact grill, which grills are sold and manufactured by Spectrum Brands, Inc. of Middleton, Wisconsin, the assignee of the subject invention.

These contact grills typically include a number of electrical and/or electronic components. As such, appropriate care should be taken when washing such contact grills to prevent damage to any such electrical and/or electronic component. Typically, upper and lower grill plates are separable from upper and lower housings so that just the grill plates can be cleaned. All electrical components including the heating elements are components of the upper and lower housings and thus are not subject to being submerged in water or put into a dishwasher.

### SUMMARY

The present invention is directed to a contact grill that includes upper and lower grill assemblies connected together by a hinge assembly. Contact grills of the present invention are advantageously easier to clean including components that can be submerged in water or washed within a dishwasher.

In one aspect of the present invention, the upper and lower grill assemblies are fully separable from one another and from the hinge assembly so that the upper and lower grill assemblies, each comprising a housing, grill plate, and heating element, are free of electrical components so that they can be submerged or washed in a dishwasher.

In another aspect of the present invention, upper and lower grill plates that are assembled with respective upper and lower heating elements are separable from an assembly of upper and lower housings connected together with a hinge assembly. All electrical components are provided within the hinge and housings assembly so that the grill plates and heating elements can be separated from the contact grill to be submerged or washed in a dishwasher.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of a contact grill of the present invention comprised of an upper grill assembly, a lower grill assembly, and a hinge assembly.

FIG. 2 is a rear angled view of the contact grill of FIG. 1 showing upper and lower hinge components.

FIG. 3 is an angled back view of the lower grill assembly.

FIG. 4 is an angled view from below of a lower grill plate.

FIG. 5 is an angled front view of the upper grill assembly.

FIG. 6 is an angled view from below of an upper grill plate.

FIG. 7 is a perspective view of the hinge assembly that corresponds to a closed position of the contact grill.

FIG. 8 is an angled front view of the hinge assembly showing the upper and lower hinge components and the upper and lower plugs to be connected with the upper and lower housings, respectively.

FIG. 9 is an exploded angled rear view of the hinge assembly including features of a floating hinge.

FIG. 10 is a perspective exploded view of the lower hinge component.

FIG. 11 is a perspective exploded view of the upper hinge component.

FIG. 12 is a cross-sectional side view of the hinge assembly showing a hinge pin as provided with a range of vertical movement as a floating hinge.

FIG. 13 is a perspective view of an alternative contact grill of the present invention that is designed for easy cleaning.

FIG. 14 is a similar perspective as FIG. 13, but with lower and upper grill plates removed.

FIG. 15 is cross-sectional view at a central location of the contact grill through the upper and lower housing assemblies and the hinge assembly.

FIG. 16 is a cross-sectional view at a shifted location from FIG. 15 showing interaction of electrical pins and sockets.

FIG. 17 is traverse cross-sectional view showing each of the electrical contacts provided by the pins and sockets for electrical connection of the lower and upper heating elements.

FIG. 18 is a cross-sectional view showing the upper heating element and its electrical connections from above.

FIG. 19 is a cross-sectional view similar to FIG. 18 but showing the lower heating element and its electrical connections from above.

FIG. 20 is a partial perspective view of the upper hinge component of the hinge assembly from a front vantage provided with a separation force application feature of the present invention.

FIG. 21 is a partial perspective view of the upper hinge component of the hinge assembly from a rear vantage provided with a separation force application feature of the present invention.

FIG. 22 is a partial perspective view of the upper hinge component of the hinge assembly provided with another separation force application feature of the present invention, including a lever mechanism.

FIG. 23 is a side view of the hinge assembly of FIG. 22 provided with a lever mechanism as a separation force application feature of the present invention.

FIG. 24 is a partial perspective view of another embodiment of the hinge assembly provided with another separation force application feature of the present invention as such feature is provided to an upper and lower component of the hinge assembly.

FIG. 25 is a partial perspective view similar to FIG. 24, but with another embodiment of a separation force application feature of the present invention.

FIG. 26 is a partial perspective view from a bottom vantage showing a separation force application feature as provided to the lower hinge component.

FIG. 27 is a partial perspective view of the upper hinge component of another hinge assembly of the present invention provided with a separation force application feature of the present invention including a user actuation mechanism for creating a separation force.

FIG. 28 is a view similar to FIG. 27 with a separation causing feature extended.

FIG. 29 is a partial top view of the upper hinge component of FIGS. 27 and 28 with a portion removed for showing the internal elements of the user actuation mechanism.

FIG. 30 is a partial side view of yet another hinge assembly provided with yet another separation force application feature.

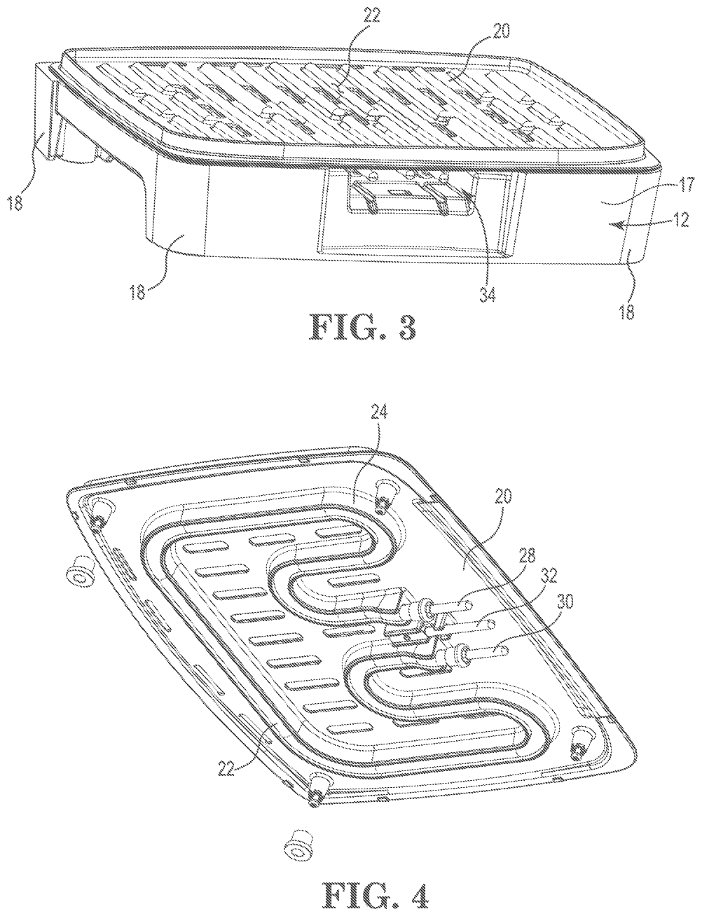

FIG. 3 is a partial side view of yet another hinge assembly provided with yet another separation force application feature.

### DETAILED DESCRIPTION

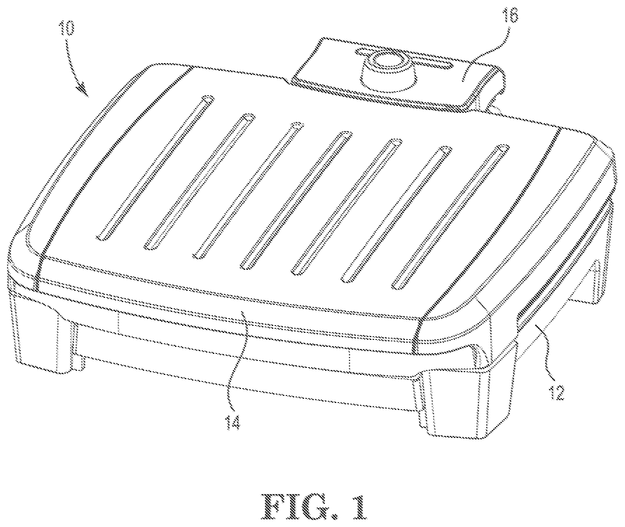

The present invention is directed to easy clean contact grill designs that allow a contact grill 10, as shown in FIG. 1, to be easily dissembled for cleaning such as for being washed in a dishwasher. The contact grill 10 comprises a lower grill assembly 12, an upper grill assembly 14, and a separable hinge assembly 16. In accordance with the present invention, the lower grill assembly 12, the upper grill assembly, and the hinge assembly 16 are each separable from one another so that the lower grill assembly and the upper grill assembly can be cleaned, such as within a dishwasher. Electrical power and temperature control elements are preferably provided within the hinge assembly 16 as separable from the lower and upper grill assemblies 12, 14, as discussed below, so that the lower and upper grill assemblies 12, 14 are safe to be submerged in water for cleaning.

As shown in FIGS. 3 and 4, the lower grill assembly 12 preferably provides a base for the contact grill 10 that comprises a lower housing 17 to be set on a surface for use and can include feet portions 18 for providing a stable base. A lower grill plate 20 closes off a top opening of the lower housing 17 and provides a grilling surface 22 that is heated as described below for cooking a food product in contact with the grilling surface 22. The grilling surface 22 is preferably ribbed to provide a desired grill pattern to a food product. The lower grill plate 20 preferably is fixed to the lower housing 17 to create the lower grill assembly 12. The lower grill plate 20 and lower housing 17 can be sealed together to prevent water from entering an interior space of the lower housing 17 when the lower grill assembly 12 is submerged in water, rinsed in water, or subjected to washing in a dishwasher. Or, the lower grill assembly can allow water within the interior space between the lower housing 17 and the lower grill plate 20, in which case, the assembly can be provided with openings or spaces that allow for water to easily drain from the interior space. Openings, spaces, or vents can be provided at an interface of the lower housing 17 and lower grill plate 20, or through either or both components themselves to further facilitate draining.

FIG. 4 shows the lower grill plate 20 disassembled from the lower housing 17 as viewed from below the lower grill plate 20. Illustrated in particular is a grooved structure 24 in a serpentine shape that receives a heating element 26 that is similarly shaped. The heating element 26 is preferably a cal-rod resistive type heating element with the understanding that other types of heating elements can instead be utilized such as including quartz or halogen type heating elements, which might require a sealed construction of the lower housing 17 and lower grill plate 20 as discussed above. A resistive heating element is preferred in that it would not be adversely affected by submersion in water. The heating element 22 can also be removable from within the grooved structure 24 or it can be fixed within the grooved structure 24, such as by a crimping technique or with the aid of mechanical fasteners, or other bonding techniques.

At the ends of the resistive heating element shown, first and second electrical contact pins 28 and 30 extend rearward from the lower grill plate 20 for connection with a power source as facilitated by the hinge assembly 16 as described below. A third electrical contact pin 32 also preferably extends rearward similarly that is connected with the lower grill plate 20 for grounding. As shown in FIG. 3, the contact pins 28, 30, and 32 are accessible at the rear side of the lower grill assembly 12 through an opening 34 of the lower housing 17.

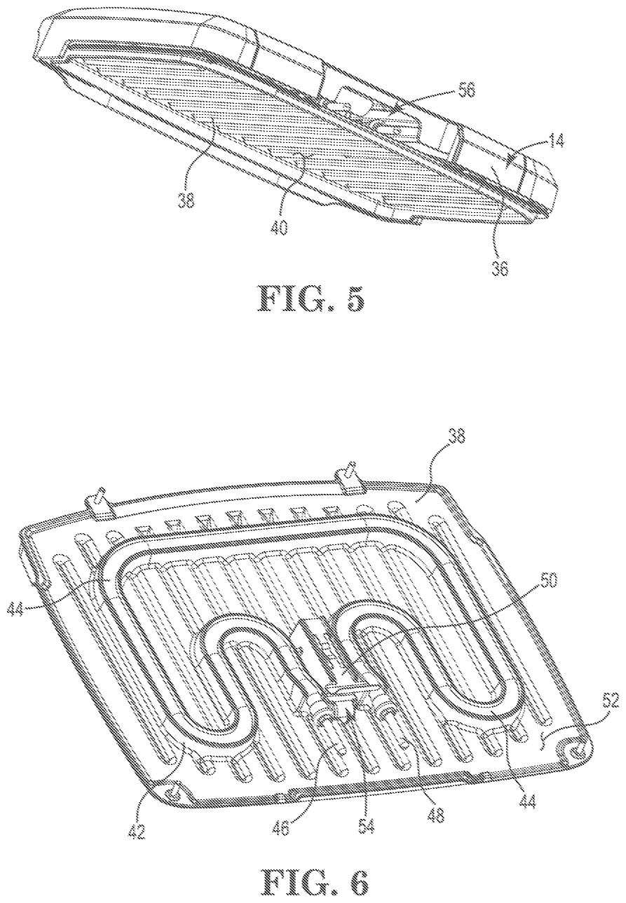

As shown in FIGS. 5 and 6, the upper grill assembly 14 preferably provides a top or lid for the contact grill 10 that comprises an upper housing 36. An upper grill plate 38 closes off a bottom opening of the upper housing 36 and provides a grilling surface 40 that is heated as described below for cooking a food product in contact with the grilling surface 40. The grilling surface 40 is also preferably ribbed to provide a desired grill pattern to a food product. The upper grill plate 38 preferably is fixed to the upper housing 36 to create the upper grill assembly 14. Like the lower grill assembly 12, the upper grill plate 38 and upper housing 36 can be sealed together to prevent water from entering an interior space of the upper housing 36 or they can allow water within the interior space, in which case, a fit that allows for water to also easily drain from the interior space is also preferable. Openings or vents can be provided at an interface of the upper housing 36 and upper grill plate 38, or through either or both components themselves to further facilitate draining.

FIG. 5 shows the upper grill plate 38 disassembled from the upper housing 36 as viewed from below the upper grill plate 38. Illustrated is a grooved structure 42 in a serpentine shape that receives a heating element 44 that is similarly shaped. Preferably, the shape of the grooved structure 42 and heating element 44 is similar to that of the grooved structure 24 and heating element 26 of the lower grill plate 20. The heating element 44 is preferably the same as the heating element 26 of the lower grill plate 20, such as a cal-rod resistive type heating element with the understanding that other types of heating elements can instead be utilized such as including quartz or halogen type heating elements, which might require a sealed construction of the lower housing 17 and lower grill plate 20 as discussed above. A resistive heating element is preferred in that it would not be adversely affected by submersion in water. The heating element 44 can also be removable from within the grooved structure 42 or it can be fixed within the grooved structure 42, such as by a crimping technique or with the aid of mechanical fasteners, or other bonding techniques.

At the ends of the resistive heating element 44 shown, first and second electrical contact pins 46 and 48 extend rearward from the upper grill plate 38 for connection with a power source as facilitated by the hinge assembly 16 as described below. A plate 50 is also shown connected with and spaced from a lower surface 52 of the upper grill plate 38 as preferably also positioned between the contact pins 46 and 48 to provide an opening 54 for receiving a temperature feedback probe, as described below. As shown in FIG. 5, access to the contact pins 46 and 48 and access to the opening 54 is provided at the rear side of the upper grill assembly 14 through an opening 56 of the upper housing 36.

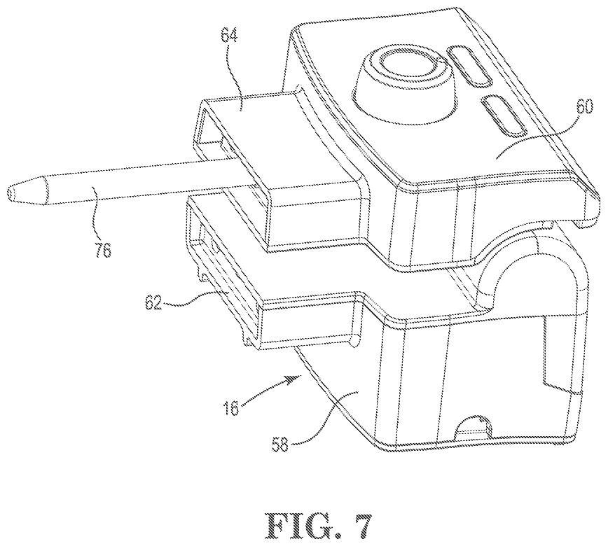

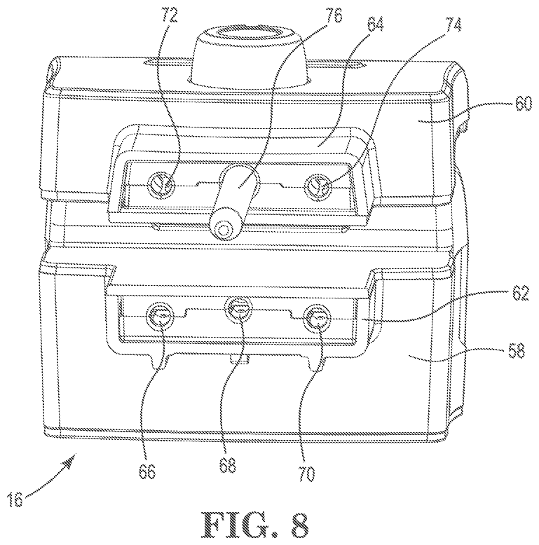

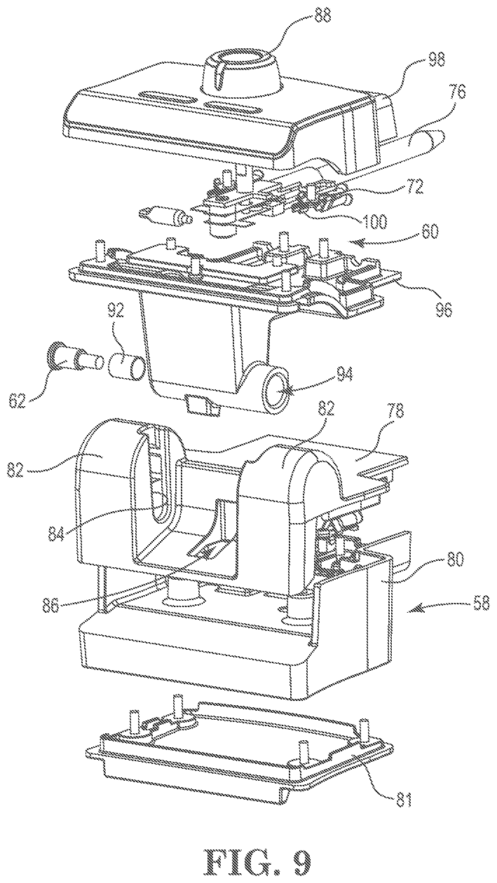

The hinge assembly 16 is shown in greater detail within FIGS. 7-12. The hinge assembly 16 is shown as a separate unit that has been separated from the lower and upper grill assemblies 12 and 14. The hinge assembly 16 comprises a lower hinge component 58 and an upper hinge component 60 that are connected together by a pair of hinge pins 62 (one shown in FIG. 9). A single hinge pin could be provided instead. As such, the lower and upper hinge components are pivotal to one another over at least a desired range sufficient for fully opening and closing the contact grill 10. This pivotal connection will be discussed in greater detail below.

The lower hinge component 58 comprises a lower plug 62 to be inserted within the opening 34 of the lower housing 17 and for receiving the first, second, and third electrical contact pins 28, 30, and 32 within first, second, and third electrical sockets 66, 68, and 70 of the lower plug 62. The structure surrounding the sockets 66, 68, and 70 that comprises the lower plug 62 preferably is frictionally fit within the opening 34 for maintaining the hinge assembly 16 with the lower grill assembly 12. The lower plug 62 is also preferably sized and positioned vertically so that when the hinge assembly 16 sits on a same surface as the lower grill assembly 12, the contact pins 28, 30, and 32 align with the sockets 66, 68, and 70. It is contemplate that mechanical connection components, such a detents, biased pins, fasteners and the like could be used to enhance connection of the lower plug 62 within the opening 34 of the lower housing 17.

In a similar sense as the lower hinge component 58, the upper hinge component 60 comprises an upper plug 64 to be inserted within the upper housing opening 56 and for receiving the first and second upper electrical contact pins 46 and 48 within first and second electrical sockets 72 and 74. The upper plug 64 also comprises a temperature feedback probe 76 that extends forward from the upper plug 64 for being inserted within the opening 54 of the upper grill plate 38. Preferably, the probe 76 is shaped and extended so as to contact or nearly contact the lower surface 52 of the upper grill plate 38 at a substantially central location of the upper grill plate 38 to measure the temperature of the upper grill plate 38 and provide feedback to a control circuit discussed below. The structure surrounding the sockets 72, and 74 that comprises the upper plug 64 preferably is frictionally fit within the opening 56 for maintaining the hinge assembly 16 with the upper grill assembly 14. The upper plug 64 is also preferably sized and positioned vertically so that when the hinge assembly 16 sits on a same surface as the lower grill assembly 12 and the upper grill plate 38 is adjacent to the lower grill plate 20, the contact pins 46 and 48 align with the sockets 72 and 74. Again, it is contemplate that mechanical connection components, such a detents, biased pins, fasteners and the like could be used to enhance connection of the upper plug 64 within the opening 56 of the upper housing 36.

As it understood from the above description, the lower and upper grill assemblies 12 and 14 are easily separable from the hinge assembly 16. Specifically, the upper grill assembly 14 is separated from the hinge assembly 16 by pulling the upper grill assembly 14 forward from the hinge assembly 16 to unplug the electrical pins 46 and 48 from the sockets 72 and 74 and to remove the probe 76 from within the opening 54. The upper plug 64 also disconnects from the opening 56. Likewise, the lower grill assembly 13 is separated from the hinge assembly 16 by pulling the lower grill assembly 12 forward from the hinge assembly 16 to unplug the electrical pins 28, 30, and 32 from the sockets 66, 68, and 70. The lower plug 62 also disconnects from the opening 34. After such separations, the three units are individually available for any other manipulation, such as for cleaning the lower and upper assemblies 12 and 14 within a dishwasher.

In FIG. 9, an exploded view of the upper and lower hinge components 58 and 60 as a preferable floating hinge design. A floating hinge allows the upper grill plate 38 to be positioned above the lower grill plate 20 substantially parallel with each other but spaced apart within a given range to accommodate a food product between the upper and lower grill plates 38 and 20. As a contact grill, it is desirable to have upper and lower sides of any food product in contact with the upper and lower grill plates 38 and 20 during cooking. The floating hinge accommodates contact grilling.

The lower hinge component 58 as shown can comprise first and second portions 78 and 80 and a bottom 81. First portion 78 can include ears 82 that each comprise a vertical slot 84 (only one shown) behind which a head portion of each hinge pin 64 can be positioned to allow the hinge pins 64 to move along the slots 84. The first portion 78 also preferably includes an opening 86 through which wires of a power and control circuit can pass to the upper hinge component 60. The second portion 80 preferably provides an internal volume to accommodate wiring and all electronic components. A power switch 88 is shown as can be connected along a power circuit for energizing and de-energizing the power circuit. The power circuit includes wiring to supply power to the lower and upper heating elements 22 and 44 under the control of any temperature control unit that can include a temperature setting device as are well known. For example, a temperature setting knob can be positioned on the first portion 78 and a controller, such as including a microcontroller, can be housed within the first portion 78 or the second portion 80. The controller can provide power together or selectively to the lower and upper heating elements 22 and 44. The temperature feedback probe 76 can provide an input to the controller as well. The power switch 88 would provide power throughout a power circuit under the control of the controller. Power can be provided to the lower hinge component 58, such as by a power cord connectable to a household power circuit (not shown) that is connected with the power switch within the second portion 80.

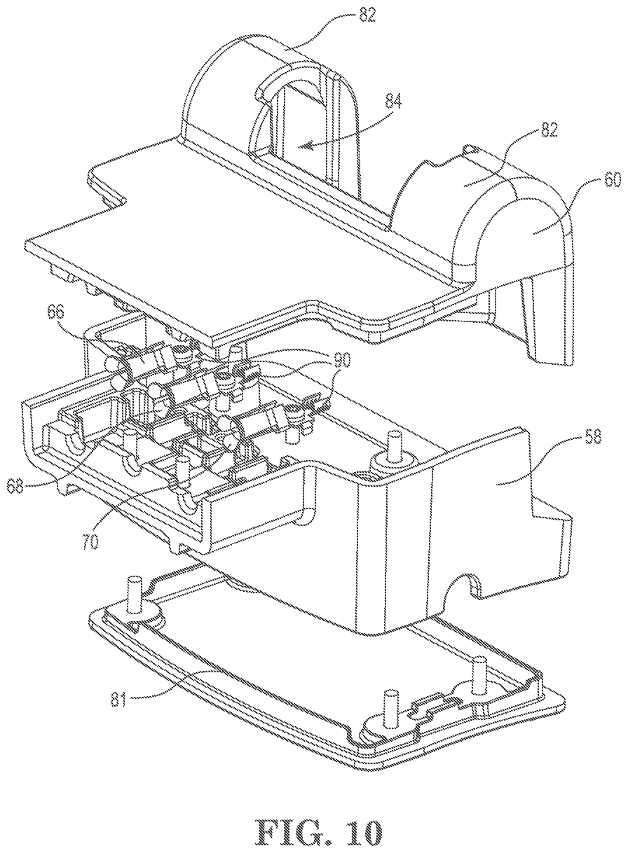

As shown in FIG. 10, electrical wiring connectors 90 are provided as extensions of the sockets 66, 68, and 70 as such sockets are supported by the first and second portions 78 and 80 of the lower hinge component 58. The connectors 90 are provided to connect with positive, neutral, and ground wires of the power circuit and for energizing the lower heating element 22.

Referring back to FIG. 9, the hinge pins 62 connect then upper hinge component 60 with the lower hinge component 58. Specifically, each pin 62 can be fit within a bushing 92 that can be tightly fit within an elongate passage 94 of the upper hinge component. The passage 94 and pins 62 define the axis of pivotal movement of the upper hinge component 60 to the lower hinge component 58.

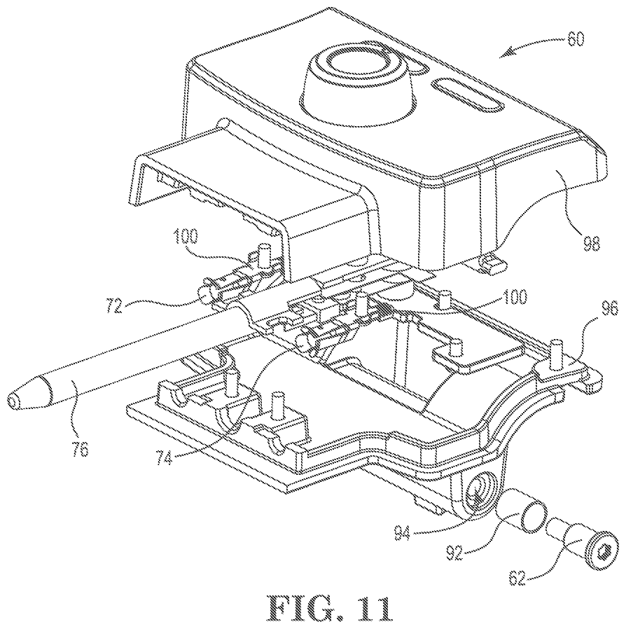

FIGS. 9 and 11 show the upper hinge component 60 as exploded views, one from the rear and one from the front, respectively. As shown, the upper hinge component 60 preferable comprises first and second portions 96 and 98 that are fit together to create an internal space for wiring and control components as needed and to support the probe 76 in place as well as the sockets 72 and 74. Extensions of the sockets 72 and 74 include wire capture connections 100 similar to connectors 90 for connection with the power circuit to selectively energize the upper heating element 44 under control as described above.

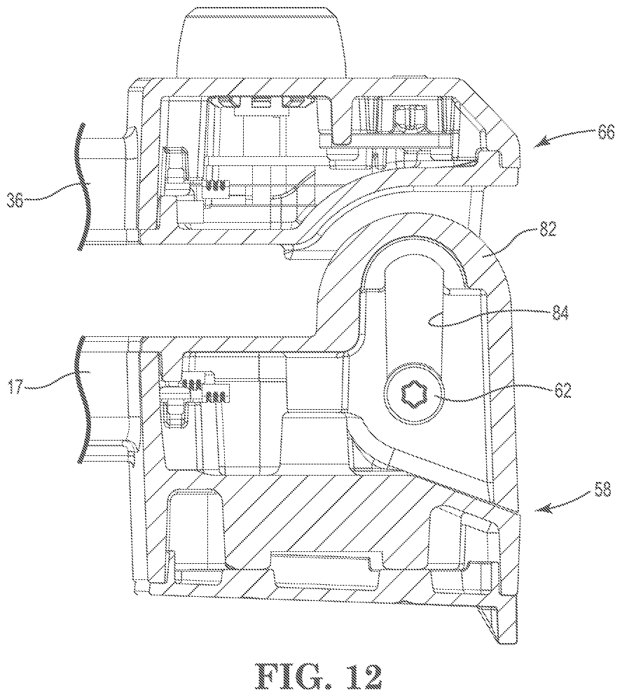

FIG. 12 is a cross-sectional view that shows the lower housing 17 plugged with the lower hinge component 58 and the upper housing 36 plugged with the upper hinge component 60. As seen at the hinge pin 62 as it is positioned at the bottom of the slot 82, the lower and upper housings 17 and 36 are as close as they get to one another. The slot 82 shows the range of movement of the lower and upper housings 17 and 36 away from one another from that bottom point.

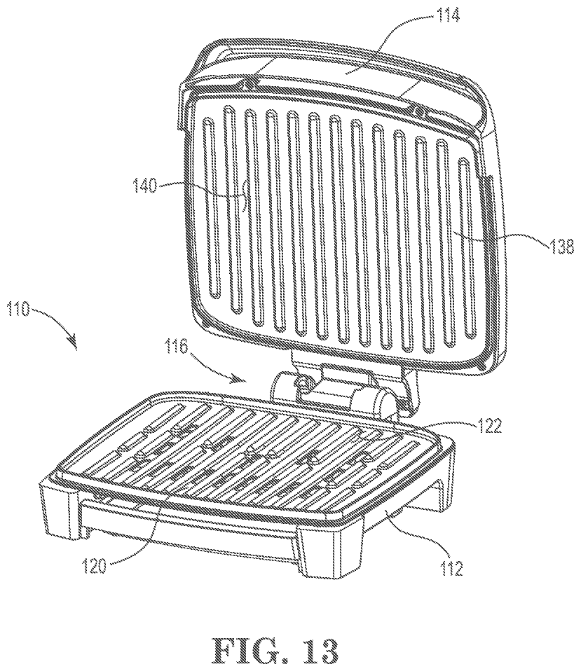

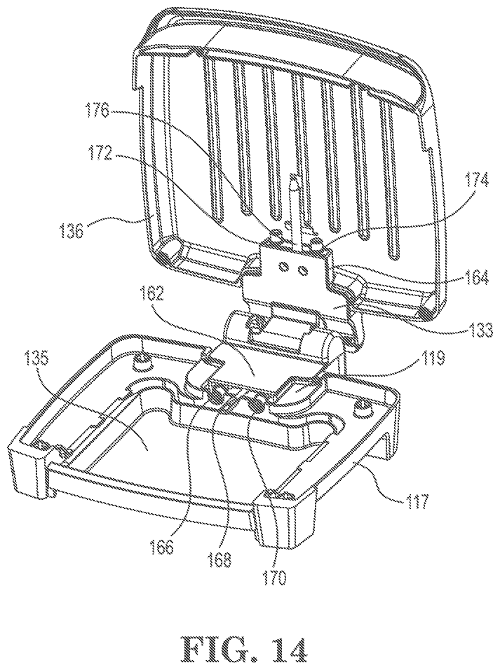

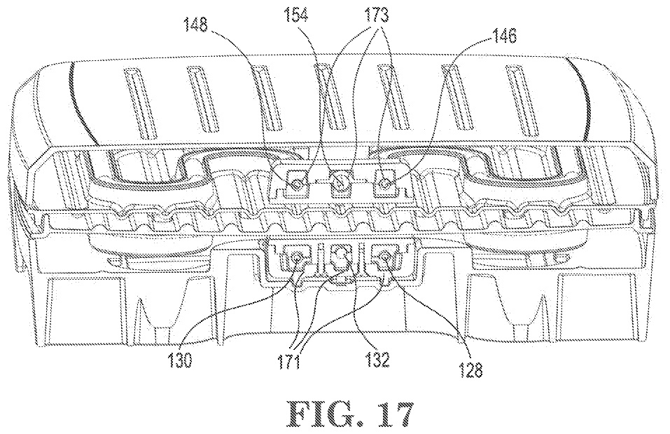

Another alternative embodiment of an easy clean grill is shown in FIGS. 13-19 and described as follows. An easy clean contact grill 110 is illustrated in FIGS. 13 and 14 as basically comprising a lower housing assembly 112, and upper housing assembly 114, and a hinge assembly 116. The contact grill 110 is similar to the contact grill 10 in that the hinge assembly 116 can be substantially the same as hinge assembly 16 but instead of the upper housing 36 and lower housing 17 being made as non-separable upper and lower housing assemblies 14 and 12, respectively, that are completely unplugged from the hinge assembly 16, an upper housing 136 and a lower housing 117 of this embodiment are in affect made connected with or integrated with the upper hinge component 60 and lower hinge component 58, respectively, of hinge assembly 16. Preferably, the hinge assembly 116 comprises a floating hinge as described above as hinge assembly 16 in the same manner.

In this regard, FIG. 14 shows the contact grill 110 with the lower and upper grill plates 120 and 138 removed. Preferably, a lower heating element 122 is fixed in a lower groove structure 124 of the lower grill plate 120, such as by crimping the lower groove structure at multiple locations or by other mechanical fasteners or bonding techniques. Likewise, an upper heating element 144 is preferably fixed in an upper groove structure 142 in a similar manner. That way, the resistive-type heating elements 122 and 144 can be removed with the lower and upper grill plates 120 and 138 to be cleaned such as by being placed in a dishwasher.

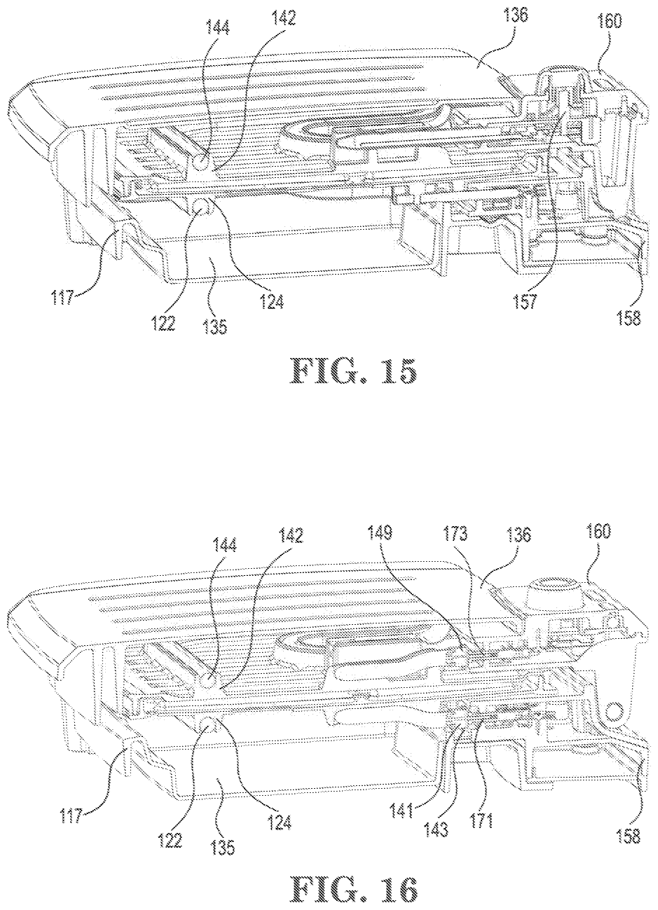

The lower housing 117 is integrated with the lower hinge component 158 and the upper housing 136 is integrated with the upper hinge component 160. These components can be integrated as being formed as a single element or they can be integrated from separate components fixed together by fasteners or bonding techniques. The upper housing 158 pivots to the lower housing 117 in the same way as described above with hinge assembly 16. As shown in FIG. 14, a lower support bracket 119 can be fit partially within the lower housing 117 to provide strength to the lower housing 117, in particular around the hinge assembly 116 and rear portion of the lower housing 117. Likewise, and upper support bracket 133 can be partially fit within a rear region of the upper housing 136 for strength near the hinge assembly 116 as well. Preferably, the support brackets extend to create at least portions of the lower and upper hinge component portions, such as shown in FIGS. 15 and 16 for strength specifically at the hinge assembly 116. Such support brackets are optional and can be varied in any different shape and extent in order to provide a robust contact grill 110 as desired. Such support brackets may be made for strength, and as such can be fabricated from metal or stronger plastic or other appropriate materials for a heated environment than may be used for the lower and upper housings 117 and 136. A drip tray 135 is also shown slid within the lower housing 117 to receive food particles and/or liquids during cooking, which drip tray 135 is preferably removable by sliding outward from the lower housing 117 for cleaning, such as being in a dishwasher.

The lower housing 117 can also include a slide element supported to the lower housing 117 and a guided element that is spring biased toward a release button. The guided element can interact with one or more clips so that upon pushing of the release button inwardly, the guided element can shift against the bias of the spring force to interact with the clips to move them in a non-engagement position with an edge portion of the lower grill plate 120 for removal. Likewise, an upper slide can be supported to the upper housing 136 within which a guided element can be biased toward another release button. Pushing that release button inwardly can cause the guided element to shift against its spring bias to interact with and release one or more clips for removal of the upper grill plate 138. Such lower and upper slides can be secured to strategically placed connection points of the lower and upper housings 117 and 136, such as by mechanical screws or other bonding techniques.

An extension 134 of the upper bracket 133 is shown in FIG. 14 extending centrally of the upper housing 136. Supported by the extension 134 is a thermostat 157 that preferably is in contact with a backside surface of the upper grill plate 138. The thermostat 157 is provided instead of a temperature feedback probe of the contact grill 10 to provide temperature feedback data to an electronic control system in the same manner as discussed above as may preferably be provided within the hinge assembly 116. A wiring harness can be accommodated as well as appropriately connected with the thermostat 157 and the control components. As shown, preferably the thermostat is spring biased against the backside surface of the upper grill plate 138.

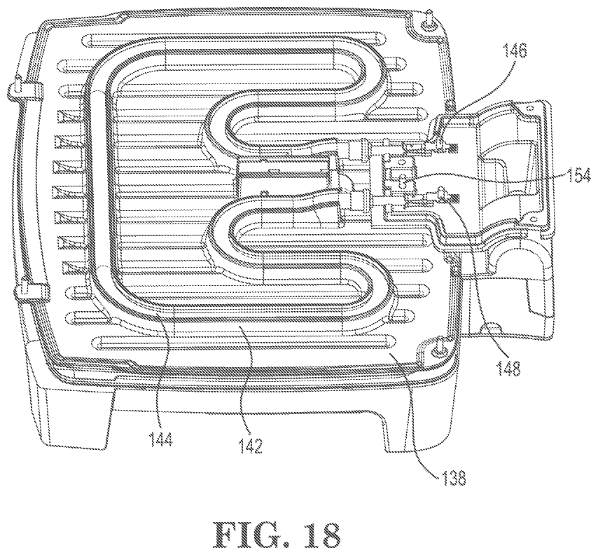

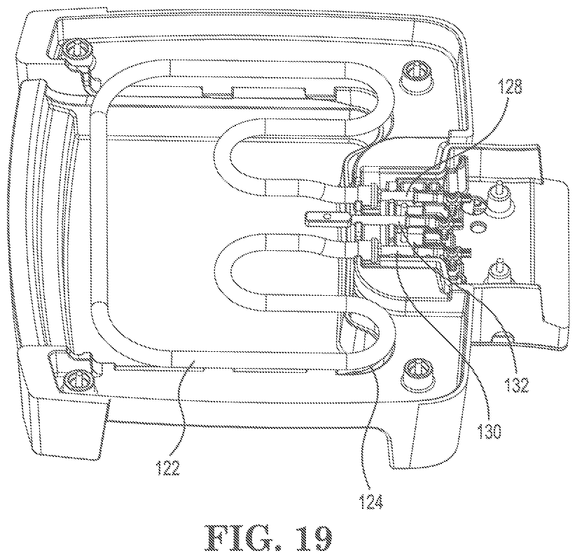

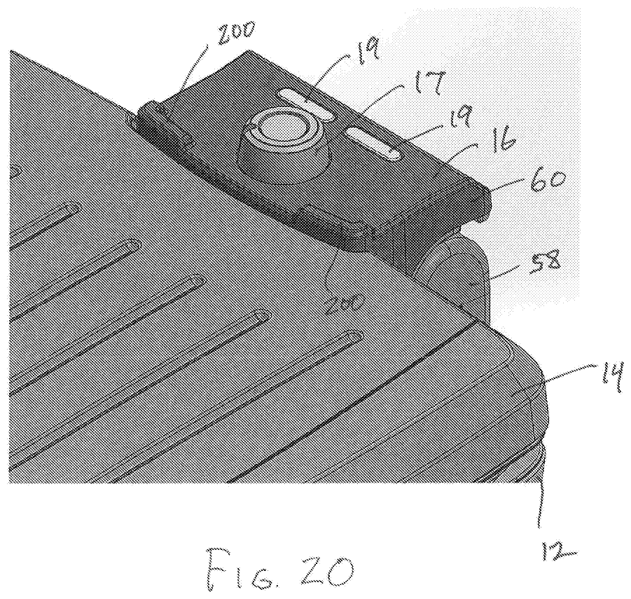

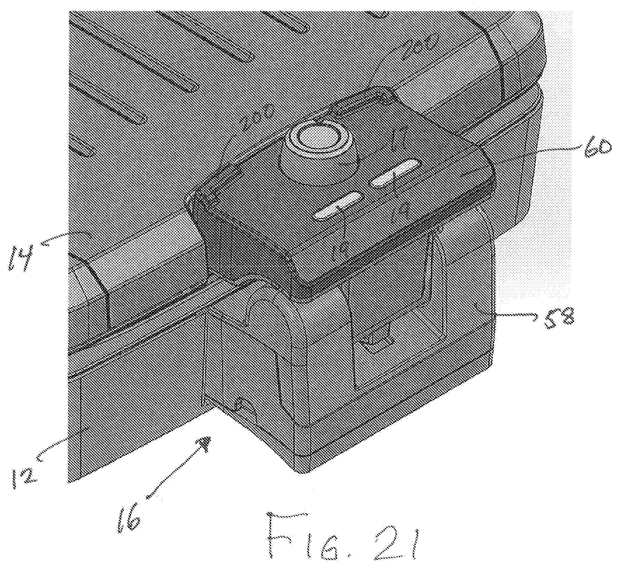

As shown in FIG. 14, a lower plug 162 is extended from the hinge assembly 116 to position sockets 166, 168, and 170 to be connected with pins 128, 130, and 132 (see FIG. 19) that extend from the lower heating element 122. The electrical connections can be the same as described above for contact grill 10. An upper plug 164 is also shown in FIG. 14 providing sockets 172, 174, and 176 to be connected with pins 146, 148, and 154 (see FIG. 18) that extend from the upper heating element 144. In this case, the middle upper pin 154 can be connected to ground the upper grill plate 138 similar to how the middle lower pin 132 can be used to ground the lower grill plate 120 similar to the grounding of the lower grill plate 20 of contact grill 10.

As shown best in FIGS. 15, 16, and 17, each of the sockets for receiving the electrical connection pins from the lower and upper grill plates 120 and 138 are preferably spring biased contacts to enhance contact of the respective pins and sockets. Specifically, springs 171 bias conductive contact pads toward the pins 128 and 130 and the pin 132 that is in the form of a conductive blade. Springs 173 urge conductive contact pads toward the pins 146 and 148 and the pin 154 also in the form of a conductive blade.

As above, each of the conductive contact pads of the sockets 166, 168, 170, 172, 174, and 176 can be electrically connected with a power circuit for heating the heating elements 122 and 144 for controlled cooking under the temperature feedback from the thermostat 157. A microprocessor and/user control features can preferably be provided to and within the hinge assembly 116 as such components are themselves conventionally known. The contact grill 110 provides an improved grill from a cleaning standpoint in that the upper and lower grill plates 120 and 138 are removable along with the heating elements 122 and 144, respectively, the drip tray 135 can also be removed, and easy access is provide within the lower and upper housings 117 and 136 for cleaning without removal from the hinge assembly 116. The design of the upper and lower housing assemblies 112 and 114 provide for little if any cooking particles and/or liquids into the lower and upper housings 117 and 136.

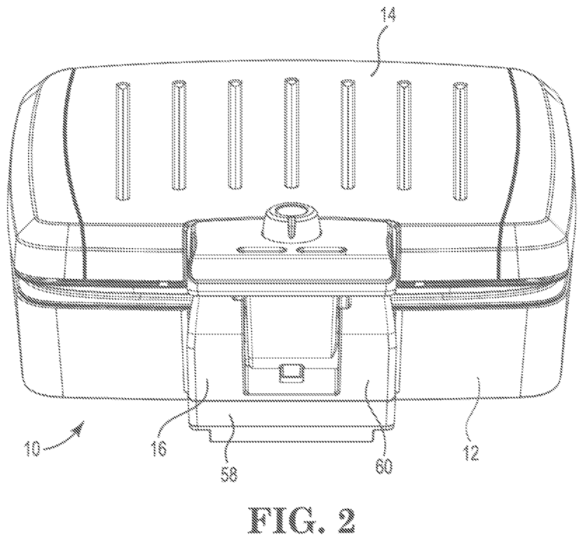

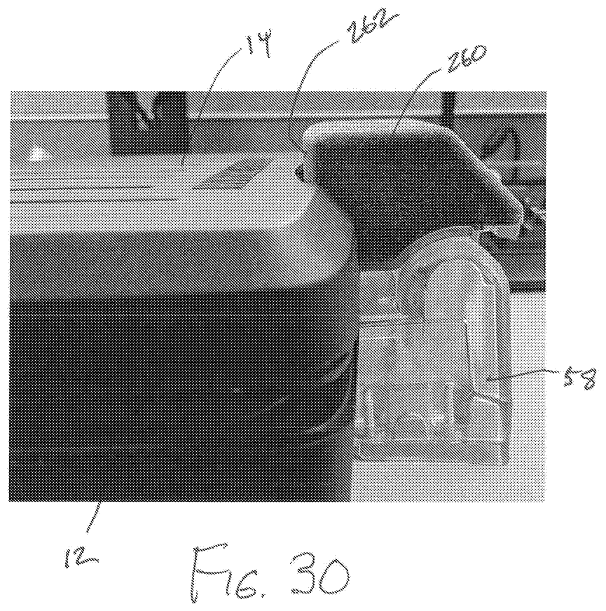

In the case of a contact grill 10 such as described above with reference to FIGS. 1-12, it can be desirable to enhance an ability to separate the hinge assembly 16 from the lower and upper grill assemblies 12, 14, respectively. FIGS. 20-31 show a number of different ways to enhance this separation ability so that the hinge assembly 16 can be more easily separated from the lower grill assembly 12 and upper grill assembly 14. A temperature setting knob 17 is shown along with indicator lights 19 on a top surface of the upper hinge component 60.

It is understood that a separation process can be looked at from two different vantages. The hinge assembly 16 can be pulled from the combination of the lower grill assembly 12 and upper grill assembly 14 with the lower and upper grill plates 20, 38 nested together as shown in the FIGS. 15-16 example to be horizontally fixed together. A user would grab or apply pressure to a top surface of the upper grill housing 14 while pulling out the hinge assembly 16. Such a separation force would need to overcome the frictional engagement of the lower and upper plugs 62, 64 including the engagement of each of the electrical contact pins 28, 30, 32 46, and 48 with their respective sockets 66, 68, 70, 72, and 74, which are preferably designed to interact sufficiently to provide needed electrical connectivity. Alternatively, the hinge assembly 16 can be pushed from the combination of the lower grill assembly 12 and the upper grill assembly 14 by applying a force to the hinge assembly 16, such as to a surface of the upper hinge component 60, while maintaining the lower and upper grill assemblies 12, 14 together in position or while also applying a reversely directed force to the lower and upper grill assemblies 12, 14, such as may be applied to any hinge side surface portion of either of the lower and upper grill assemblies 12, 14.

In a first example shown in FIGS. 20 and 21, a one or more of force applications features can be provided to the upper hinge component 60. Shown is a pair of thumb push ridges 200 that are positioned to receive the application of a force in the separation direction to the hinge assembly 16. A user can apply a separation force by way of the user thumbs to the ridges 200 while also applying a reverse force to the upper grill assembly 14 by way of the user's fingers. It is contemplated that a single such ridge can be provided or any plurality of such ridges as designed for user force application. Such a ridge 200 can be provided at other locations on the upper hinge component 60 just as long as the user can access the feature for applying a separation force.

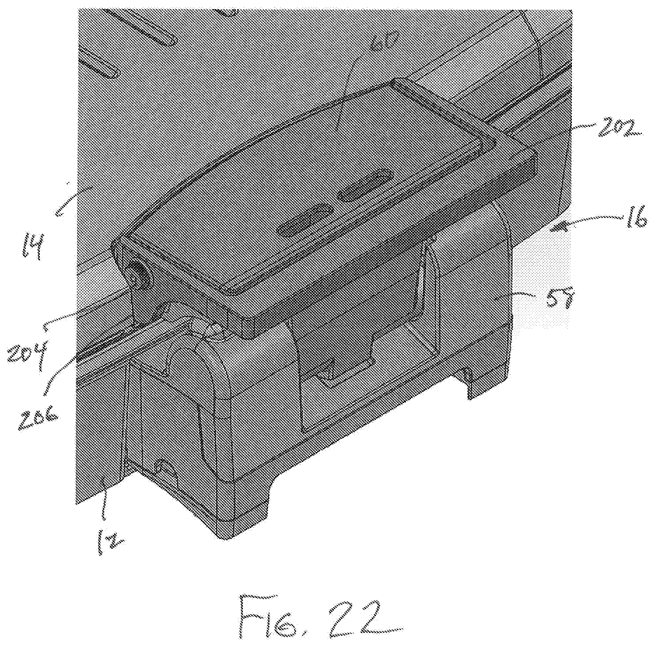

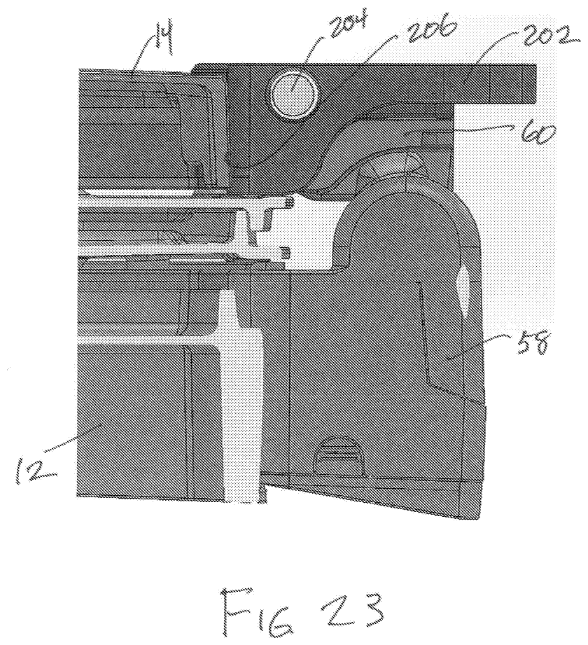

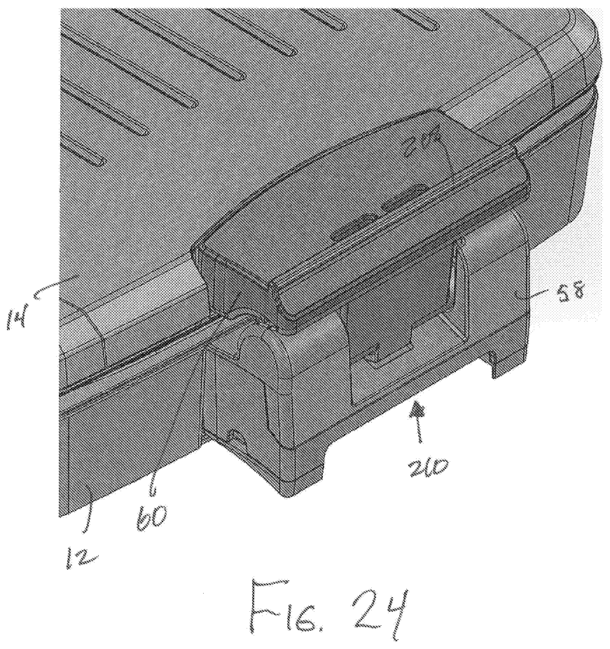

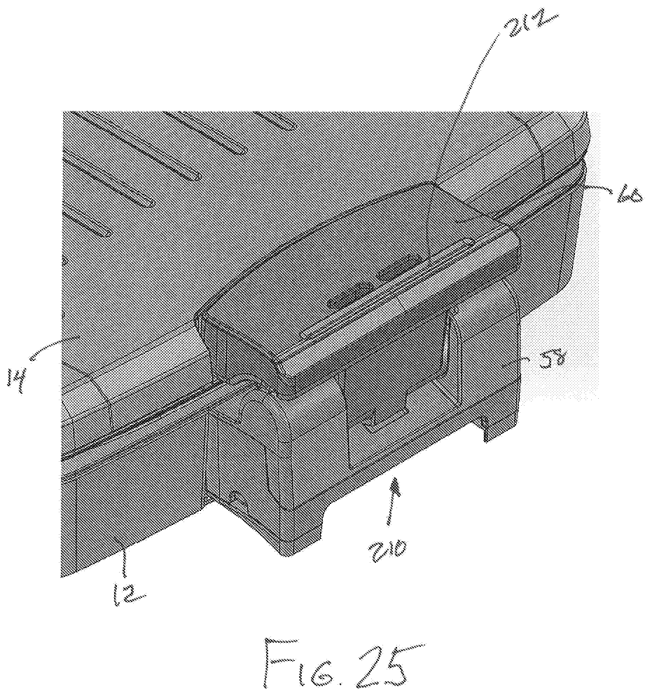

Another example is illustrated in FIGS. 22 and 23, where the application of a separation force can be facilitated by a user's manipulation of a lever 202 that can be pivotally connected to the upper housing component 60 by pins 204. The lever 202 is preferably designed to partially surround a perimeter of the upper hinge component 60 in a grill use position so that is can be pivoted downwardly away from grill use position to cause a separation of the hinge assembly 16 from the lower and upper grill assemblies 12, 14. As shown, such a downward pivotal movement of the lever 202 about pins 204 causes a surface portion 206 into engagement with a side surface portion of the upper grill assembly 14 and subsequently a separation of the lower and upper grill assemblies 12, 14 from the hinge assembly 16. Such an arrangement has the advantage of the lever 202 compounding the applied force by a user to a greater separation force. It is contemplated that other type user mechanisms can be used instead of the lever system shown in FIGS. 22 and 23 where a user's applied force moves a feature so that the feature engages with any portion of the lower and upper grill assemblies 12, 14. A different lever arrangement can otherwise be applied to the lower hinge component 58 or elsewhere to the upper hinge component 60.

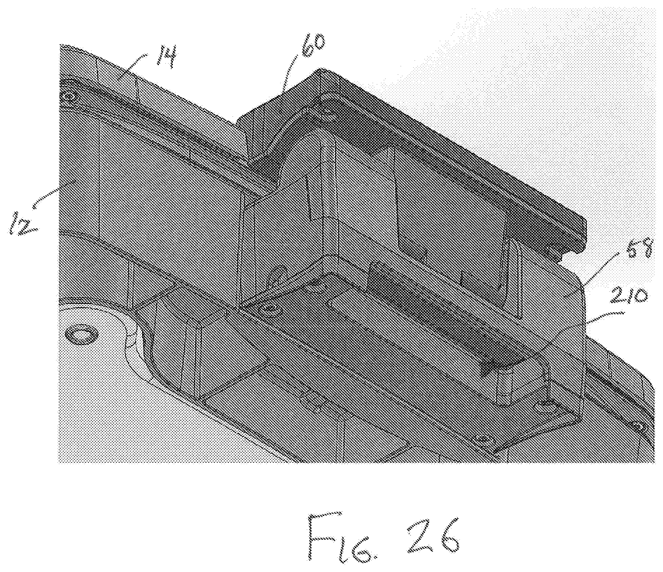

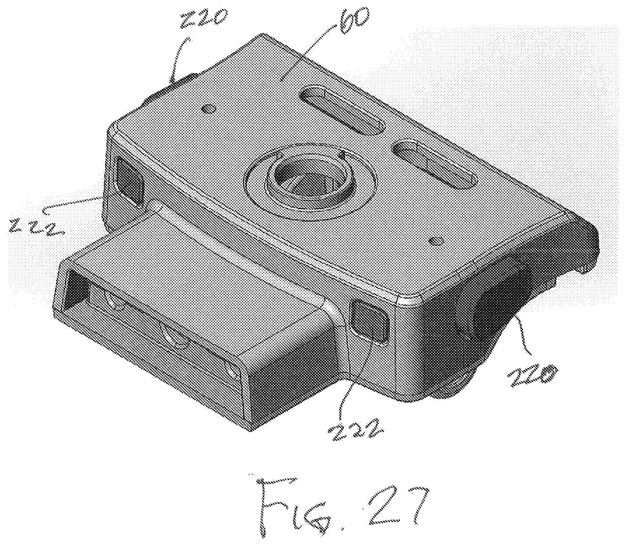

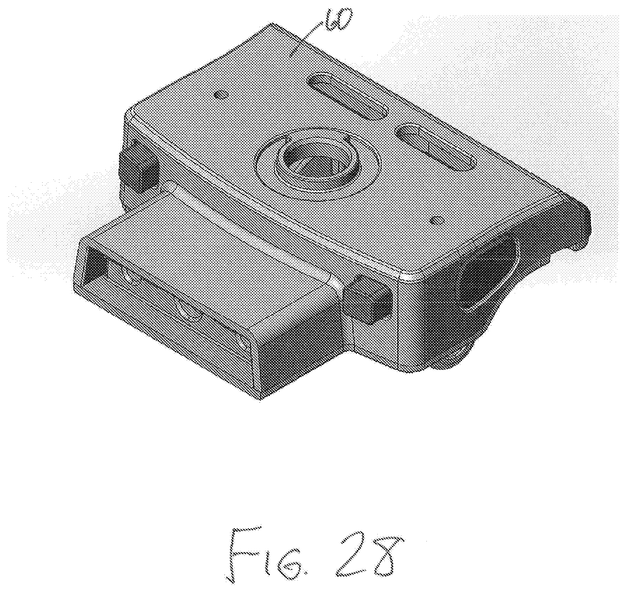

FIG. 24 shows another example of a feature provided to facilitate the application of a separation force to the upper hinge component 60 that can be used for pulling the hinge assembly 16 from the lower and upper grill assemblies 12, 14. Preferably, a ridge 208 is provided to the top surface of the upper hinge component 60, but differently from the ridges 202 of FIGS. 20 and 21, spaced further away from the upper grill assembly 14. Any number of such ridges is contemplated as positioned anywhere to the upper hinge component 60 with user access. In addition to the ridge 208 to the upper hinge component 60, a second feature such as an undercut grip 210 can be provided to the lower hinge component 58. The undercut feature 210 is shown best in FIG. 26 to create an open space behind a portion of the lower hinge component 58 back surface that allows a user's fingers to be inserted within the lower hinge component 58. A user can thus apply a thumb to the ridge 208 while applying fingers into the undercut feature 210 for pulling the hinge assembly 16 from the lower and upper grill assemblies 12, 14. Such an arrangement provides a vertical style grip. FIG. 25 shows a similar vertical style grip but with a groover 212 on the top surface of the upper hinge component 60 instead of a ridge. Again, it is contemplated that the separation feature for the upper hinge component can take any form that allows a user an enhanced grip for pulling the hinge assembly 16. Likewise, the lower hinge component 58 can be provided with a cutout or other similar feature to provide a vertical grip allowing both the upper and lower hinge components 60, 58 together.

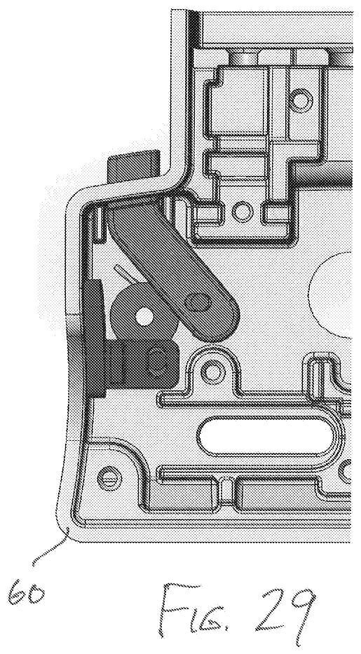

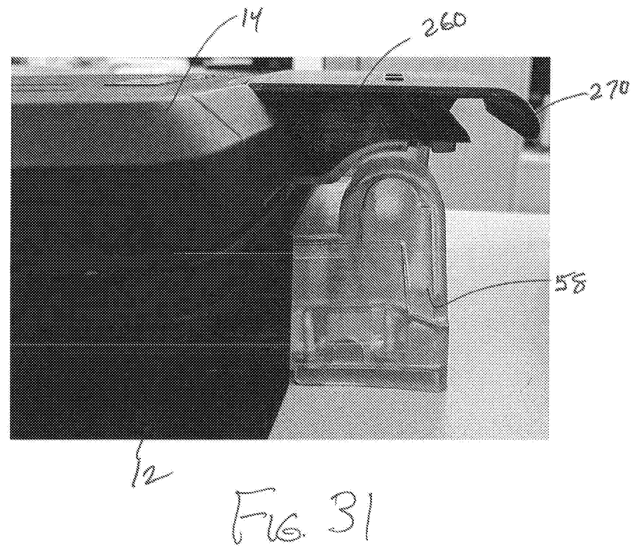

FIGS. 27-29 show another example of a user manipulated mechanism that can transfer a user applied force to a mechanism applied separation force. One or more buttons 220 can be movably supported to the upper hinge component 60, such as at side surfaces as shown. Depression of the one or more buttons can selectively cause an extension of push elements 222, such as from a grill facing surface of the upper hinge component 60 to be applied to any side surface of the upper grill assembly 14, such as also describe above with reference to FIGS. 22 and 23. Preferably, a pair of buttons 220 and push elements 222 are provided at opposite sides of the upper hinge component 60. When the push elements 222 are pushed at the same time, both push elements 222 extend to provide a separation force against the lower and upper grill assemblies 12, 14. As shown in FIG. 29, a scotch yoke mechanism can be utilized to transfer linear motion of the buttons 220 perpendicularly to the push elements 222 as such is operatively mounted within the upper hinge component 60. It is contemplated that other arrangements and mechanisms can be used to translate such movements. Also, biasing elements such as springs can be used to enhance the application of the separation force. For example, the push element 222 movement can be supplemented by a biasing force. Other push elements can be provided as well that are spring driven after being released by a user manipulate mechanism. Such a feature can be provided to any of the upper hinge component 60, the lower hinge component 58, the upper grill assembly 14, or the lower grill assembly 12, or any combination thereof.

FIGS. 30 and 31 show yet more examples of features that facilitate both the application of a push separation force and a pull separation force. FIG. 30 shows simply an enlarged upper hinge component 260 that provides a push surface 262 above the upper grill assembly 14. FIG. 31 shows a pull feature 270 providing a user grip the is extended from the upper hinge component 260. Many other such push and pull enhancement features can be applied to the lower and upper grill assemblies 12, 14.

What is claimed is:

1. A contact grill for cooking a food product comprising:
a lower grill assembly comprising a lower housing and a lower grill plate connected together and to be supported for use on a surface, the lower grill plate provided with a lower heating element having electrical contacts extending from the lower heating element;
an upper grill assembly comprising an upper housing and an upper grill plate connected together to be positioned above the lower grill plate for contact cooking of a food product from above and below, the upper grill plate provided with an upper heating element having electrical contacts extending from the upper heating element; and
a hinge assembly including a lower hinge component and an upper hinge component pivotally connected together to allow pivotal relative movement, the hinge assembly also including a power circuit that is connectable to a power supply, wherein the lower hinge component comprises a lower plug for connection with the lower grill plate and the upper hinge component comprises an upper plug for connection with the upper grill plate, and at least one of the lower and upper plugs including at least one power connection contact to contact with an electrical contact from the lower and upper grill plates.

2. The contact grill of claim 1, wherein the lower and upper housings are integrated with the hinge assembly and the lower and upper grill plates are fixed together with the respective lower and upper heating elements to be separable from the hinge assembly and the lower and upper housings.

3. The contact grill of claim 1, wherein the lower housing and the lower grill plate are fixed together as the lower grill assembly and the upper housing and upper grill plate are fixed together as the upper grill assembly.

4. The contact grill of claim 3, wherein the hinge assembly is separable from the lower and upper grill assemblies so that the lower and upper grill assemblies can be separated from one another for cleaning.

5. The contact grill of claim 4, wherein each of the lower and upper plugs include a power connection for the respective lower and upper heating elements.

6. The contact grill of claim 5, wherein the lower plug includes plural sockets for receiving electrical contacts from the lower heating element.

7. The contact grill of claim 6, wherein the upper plug includes plural sockets for receiving electrical contacts from the upper heating element.

8. The contact grill of claim 7, further comprising a temperature feedback probe provided from the upper hinge component for sensing a temperature of the upper grill plate and that is electrically connected with an electrical control circuit that is also connected with the power circuit.

9. The contact grill of claim 1, further comprising a separation force application feature as provided to at least one of the lower and upper hinge components that provides a surface designed to receive an application of a separation force from a user to separate the hinge assembly from the lower and upper grill assemblies.

10. The contact grill of claim 1, further comprising a separation force application feature as provided to at least one of the lower and upper hinge components that includes a user manipulated element operatively connected to one of the lower and upper hinge components so that movement of the user manipulated element causes an interaction of pushing surface portion from one of the hinge assembly and either of the lower or upper grill assemblies with a surface portion of the other of the hinge assembly and either of the lower or upper grill assemblies.

11. A method of cleaning a contact grill, the contact grill comprising:
a lower grill assembly comprising a lower housing and a lower grill plate connected together and to be supported for use on a surface, the lower grill plate provided with a lower heating element having electrical contacts extending from the lower heating element; an upper grill assembly comprising an upper housing and an upper grill plate connected together to be positioned above the lower grill plate for contact cooking of a food product from above and below, the upper grill plate provided with an upper heating element having electrical contacts extending from the upper heating element; and a hinge assembly including a lower hinge component and an upper hinge component pivotally connected together to allow pivotal relative movement, the hinge assembly also including a power circuit that is connectable to a power supply, wherein the lower hinge component comprises a lower plug for connection with the lower grill plate and the upper hinge component comprises an upper plug for connection with the upper grill plate, and at least one of the lower and upper plugs including at least one power connection contact to contact with an electrical contact from the lower and upper grill plates,
the method comprising the steps of:
separating at least the lower grill plate and the lower heating element together as a unit from the hinge assembly by unplugging the lower heating element from the hinge assembly;
separating at least the upper grill plate and the upper heating element together as a unit from the hinge assembly by unplugging the upper heating element from the hinge assembly; and
subjecting the lower grill plate and lower heating element as a unit and the upper grill plate and upper heating element as a unit to a water environment for cleaning the lower and upper grill plates.

12. The method of claim 11, wherein the lower grill plate separating step comprises separating the lower grill plate along with the lower housing and the lower heating element from the hinge assembly.

13. The method of claim 12, wherein the upper grill plate separating step comprises separating the upper grill plate along with the upper housing and the upper heating element from the hinge assembly.

14. The method of claim 13, wherein the step of unplugging the lower heating element from the hinge assembly comprises removing plural lower heating element electrical contacts from plural electrical sockets of the lower plug that are operatively connected with the power circuit.

15. The method of claim 14, wherein the step of unplugging the upper heating element from the hinge assembly comprises removing plural upper heating element electrical contacts from plural electrical sockets of the upper plug that are operatively connected with the power circuit.
